(19) United States
(12) Patent Application Publication
(10) Pub. No.: US 2017/0286163 A1
(43) Pub. Date: Oct. 5, 2017

(54) METHOD AND SYSTEM FOR PROVIDING CONTEXT INFORMATION REGARDING IoT DEVICE, AND NON-TRANSITORY COMPUTER-REDABLE RECORDING MEDIUM THEREFOR

(71) Applicant: KNOWCK CO., LTD., Seoul (KR)

(72) Inventor: Jeung Ho KIM, Seoul (KR)

(73) Assignee: KNOWCK CO., LTD., Seoul (KR)

(21) Appl. No.: 15/315,190

(22) PCT Filed: Oct. 30, 2015
(86) PCT No.: PCT/KR2015/011555

§ 371 Date: Nov. 30, 2016

(51) Int. Cl. H04L 29/08; G06K 9/00; G06Q 30/02

(52) U.S. Cl. CPC G06F 9/50; G06Q 30/0252; G06K 9/00624; H04L 67/04

(57) ABSTRACT

A method of providing context information regarding an IoT (Internet of Things) device includes acquiring primary context information which is collected for at least one IoT device, and secondary information which is derived by analyzing the primary context information; and providing the primary context information or the secondary context information to a developer device or a supplier server through a PaaS (Platform as a Service) configured to support an application or a content to be provided by the at least one IoT device.

### TECHNICAL FIELD

The various embodiments described herein pertain generally to a method and system for providing context information regarding an IoT (Internet of Things), and, also relates to a non-transitory computer-readable recording medium therefor.

### BACKGROUND

Recently, the form of media which provide contents is diversified and the way to provide the contents is automated. In an outdoor advertisement, for example, a modern method of providing advertisement contents through an IoT (Internet of Things) device such as a LED display or a LCD TV is introduced, beyond a typical method of providing advertisement contents through a stationary printed medium such as papers or films.

For example, a digital signage as a kind of IoT devices is a communication tool which an advertiser uses for marketing, advertisement, training, and so forth and through which a customer experience can be induced. Specifically, a digital signage refers to a digital imaging device configured to provide advertisement contents intended by the advertiser as well as typical broadcasting contents in a public place such as an airport, a hotel, a hospital, and so forth. The digital signage is also called a DID (Digital Information Display). Since the digital signage is equipped with a processor and a memory therein and is capable of displaying various types of contents vividly while being portable as well, it has a wide range of applications to marketing, customer services, information systems, etc., in public places such as department stores, subways, bus stops, and so forth. Further, not only the advertisement contents are provided through the digital signage, but various kinds of contents having various other purposes than the advertisement are also provided through the digital signage.

Such an IoT device may exist in a wide diversity of environments. Thus, in order to provide information more effectively through the IoT device, it is required to develop or provide an application or a content which reflects context information (or context recognition information) regarding an environment in which the IoT device is used. In this regard, there has been a demand for a technology of supporting a developer (or a supplier) who develops (or supplies) an application or a content to be provided through the IoT device to utilize information upon the context (situation) where the IoT device is situated.

### DISCLOSURE OF THE INVENTION

### Problems to be Solved by the Invention

Example embodiments of the present disclosure are conceived to meet the aforementioned requirements.

The example embodiments provide a technology of supporting a developer or a supplier who develops or supplies an application or a content to be provided by the IoT device to utilize context information regarding the IoT device by acquiring primary context information which is collected for at least one IoT device, and secondary information which is derived by analyzing the primary context information; and providing the primary context information or the secondary context information to a developer device or a supplier server through a PaaS (Platform as a Service) configured to support an application or a content to be provided by the at least one IoT device.

However, the problems sought to be solved by the present disclosure are not limited to the above description and other problems can be clearly understood by those skilled in the art from the following description.

### Means for Solving the Problems

Example embodiments of the present disclosure are as follows to meet the aforementioned requirements.

In one example embodiment, a method of providing context information regarding an IoT (Internet of Things) device includes acquiring primary context information which is collected for at least one IoT device, and secondary information which is derived by analyzing the primary context information; and providing the primary context information or the secondary context information to a developer device or a supplier server through a PaaS (Platform as a Service) configured to support an application or a content to be provided by the at least one IoT device.

In another example embodiment, a system which provides context information regarding an IoT (Internet of Things) device includes a context information management unit configured to acquire primary context information which is collected for at least one IoT device, and secondary information which is derived by analyzing the primary context information; and a PaaS (Platform as a Service) management unit configured to provide the primary context information or the secondary context information to a developer device or a supplier server through a PaaS configured to support an application or a content to be provided by the at least one IoT device.

In still another example embodiment, a non-transitory computer-readable recording medium having stored thereon computer-executable instructions that, in response to execution, cause other method, other system and the method to be performed.

### Effect of the Invention

According to the example embodiments, a developer or a supplier who develops or supplies an application or a content to be provided by an IoT device such as a digital signage is supported to utilize context information upon the IoT device. Thus, an application or a content suitable for the context (situation) can be provided by the IoT device.

Furthermore, according to the example embodiments, a library related to the context information of the IoT device can be provided to the developer. Thus, when developing the application to be provided by the IoT device, the developer is allowed to produce a function suitable for the context (situation) in which the IoT device is used.

### BRIEF DESCRIPTION OF THE DRAWINGS

FIG. 1 is a diagram illustrating a schematic configuration of an entire system for providing context information regarding an IoT device according to an example embodiment.

FIG. 2 is a diagram illustrating a detailed internal configuration of a management system 200 according to the example embodiment.

FIG. 3 is a diagram showing a configuration in which context information of an IoT device and a library are matched according to the example embodiment.

### EXPLANATION OF REFERENCE NUMERALS

100: communications network
200: management system
210: text information management unit
220: PaaS management unit
230: communication unit
240: control unit
300: supplier server
400: developer device
500: IoT device

### MODE FOR CARRYING OUT THE INVENTION

Hereinafter, example embodiments will be described in detail with reference to the accompanying drawings so that inventive concept may be readily implemented by those skilled in the art. The various example embodiments are different from each other but not intended to be mutually excluding. For example, specific shapes, structures and features described in the document may be modified without departing from the technical concept and scope of the present disclosure. Furthermore, positions or layout of individual parts within each example embodiment may also be changed or modified without departing from the technical concept and scope of the present disclosure. Thus, it is to be noted that the example embodiments to be describe below are not intended to be anyway limiting and various modifications may be made. The scope of the inventive concept is defined by the following claims and their equivalents rather than by the detailed description of the illustrative embodiments. It shall be understood that all modifications and embodiments conceived from the meaning and scope of the claims and their equivalents are included in the scope of the inventive concept. Through the drawings, like reference numerals represent like or similar parts in various aspects.

Hereinafter, the example embodiments will be discussed in detail with reference to the accompanying drawings so that the inventive concept may be easily implemented by a person having an ordinary skill in the art.

Configuration of Entire System

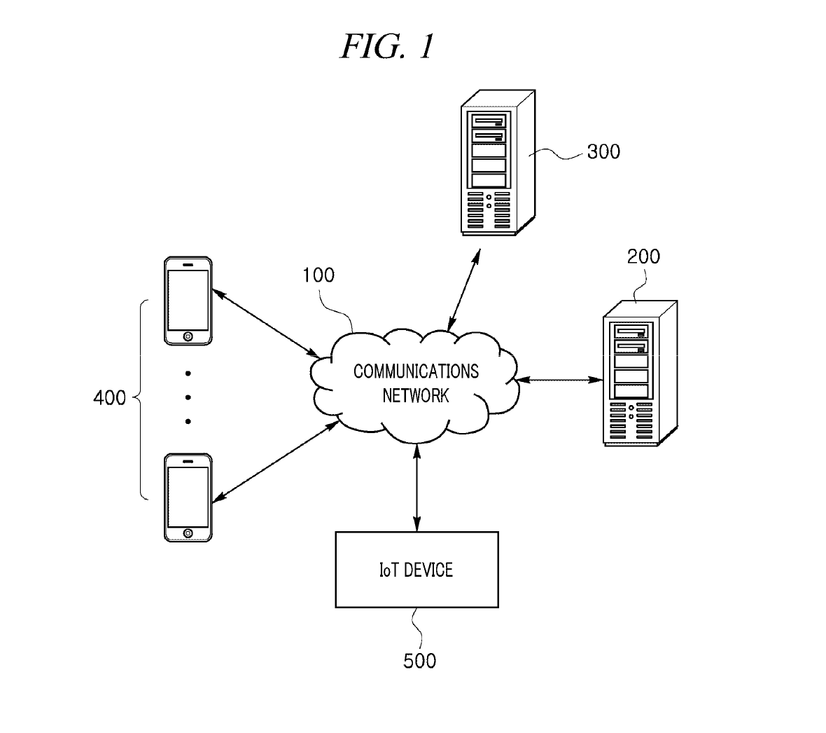

FIG. 1 is a diagram illustrating a schematic configuration of an entire system for providing context information regarding an IoT device according an example embodiment.

As depicted in FIG. 1, the entire system according to the exemplary embodiment includes a communications network 100, a management system 200, a supplier server (or a supplier device) 300, a developer device 400 and an IoT device 500.

According to the example embodiment, the communication network 100 may be implemented by wired or wireless communications networks. Specifically, the communications network 100 may be implemented by any of various communications networks such as a LAN (Local Area Network), a MAN (Metropolitan Area Network), a WAN (Wide Area Network), and so forth. Desirably, the communications network 100 in this example embodiment may be implemented by well-known Internet or WWW (World Wide Web). However, the communications network 100 is not limited to the mentioned examples, and may include a commonly known wired or wireless data communications network, a commonly known telephone network, or a commonly known wired or wireless television broadcasting network as at least a part thereof.

According to the example embodiment, the management system 200 is configured to perform a function of supporting a developer or a supplier who develops or supplies an application or a content to be provided in the IoT device 500 to utilize context information upon the IoT device 500. Specifically, the management system 200 acquires primary context information collected for at least one IoT device 500 and secondary context information obtained by analyzing the primary context information, and provides the primary context information and the secondary context information to the developer device 400 or the supplier server 300 through a PaaS (Platform as a Service) which supports an application or a content to be provided in the at least one IoT device 500.

The configuration and the operation of the management system 200 according to the example embodiment will be further elaborated later. Here, it should be noted that the above description of the management system 200 is nothing more than an example, and it is clearly understood by those skilled in the art that at least a part of functions or constituent components of the management system 200 may be embodied within the supplier server 300, the developer device 400 or the IoT device 500, or included in the supplier server 400, the developer device 400 or the IoT device 500 when necessary.

Meanwhile, according to the example embodiment, the management system 200 is capable of performing a function of providing source data of the content provided by the IoT device 500. Alternatively, a content providing server (not shown) configured to provide the source data of the content may be provided as an independent component from the management system 200.

According to the example embodiment, the supplier server 300 is configured to perform a function of supplying an application or a content that may be provided by the IoT device 500. Here, according to the example embodiment, the application or the content supplied from the supplier server 400 may be developed or produced through the PaaS which is provided by the management system 200.

Further, according to the example embodiment, the developer device 400 is a digital device having a function of allowing the developer to access and communicate with the management system 200, the supplier server 300 or the IoT device 500. The developer device 400 is not particularly limited as long as it is implemented by a digital device equipped with a memory and a microprocessor and thus has an operation ability. By way of non-limiting example, a smart phone, a tablet, a desktop computer, a laptop computer, a workstation, a PDA, a web pad, a mobile phone, or the like may be used as the developer device 400.

Further, according to the example embodiment, the developer device 400 may include a preset application (or program module) (not shown) according to the PaaS which supports the developer to develop an application or create a content. This application is distinguished from the application which is performed by the IoT device IoT 500 and may be downloaded from the management system 200 or a commonly known web server (not shown) to the developer device 400. Meanwhile, characteristics of the application belonging to the developer device 400 may be substantially similar to those of a context information management unit 210, a PaaS management unit 220, a communication unit 230 and a control unit 240 of the management system 200 to be described later. Here, at least a part of the application belonging to the developer device 400 may be replaced by a hardware device or a firmware device capable of performing substantially the same or equivalent function as that of the application, when necessary.

According to the example embodiment, the IoT device 500 is configured to perform a function of implementing (or playing) the application or the content developed by the developer device 400 or supplied from the supplier server 300.

To elaborate, according to the example embodiment, the IoT device 500 may include a display such as a LCD panel or an OLED panel and an audio equipment such as a speaker for sound output.

Further, the IoT device 500 according to the example embodiment may be implemented by a digital signage installed in public places such as a department store, a subway, a bus stop, an air port, a hotel, a hospital, and so forth, but not limited thereto.

Configuration of Management System

Now, an internal configuration of the management system 200 and functions of individual components thereof will be explained according to the example embodiment.

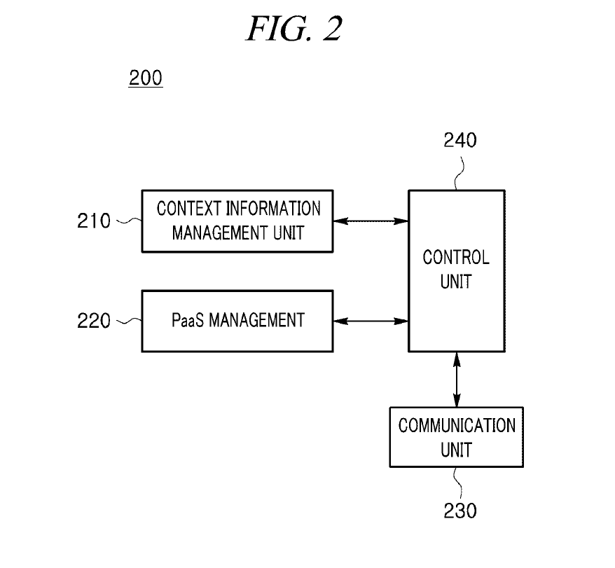

FIG. 2 is a diagram illustrating the internal configuration of the management system 200 according to the example embodiment in detail.

As illustrated in FIG. 2, the management system 200 according to the example embodiment includes the context information management unit 210, the PaaS management unit 220, the communication unit 230 and the control unit 240. In the example embodiment, at least a part of the context information management unit 210, the PaaS management unit 220, the communication unit 230 and the control unit 240 may be a program module which communicates with the supplier server 300, the developer server 400 or the IoT device 500. This program module may be included in the management system 200 in the form of an operating system, an application program module or other program modules and, physically, may be stored in various types of commonly known storage devices. Alternatively, this program module may be stored in a remote storage device which is capable of communicating with the management system 200. Meanwhile, this program module may include, but not limited to, a routine, a program, a sub-routine, an object, a component, a data structure for implementing a specific abstract data type or a specific operation to be described later.

According to the example embodiment, the context information management unit 210 is configured to perform a function of acquiring primary context information which is collected for at least one IoT device 500.

To elaborate, according to the example embodiment, the primary context information includes all types of information that can be utilized to understand the context (situation) where the IoT device 500 is used. This primary context information may include information upon the state of the IoT device 500 itself, information detected by a sensor (not shown), information collected from an external server (not shown), and so forth. By way of example, the primary context information according to the example embodiment may include, but not limited to, physical or logical information upon hardware of the IoT device 500 as a target of management, information upon an application or content stored in the IoT device 500 as the target of management, sensing information acquired from various sensors such as a camera, a microphone, an infrared sensor, an ultrasonic sensor, a pressure sensor, a temperature sensor, a static electricity sensor, and so forth which are provided in the IoT device 500 as the target of information, and public information upon weather, temperature, time, data, traffic, air quality, geography, etc. collected from an external server.

Furthermore, according to the example embodiment, the context information management unit 210 is also configured to perform a function of acquiring secondary context information by analyzing the primary context information. According to the example embodiment, the analysis process of drawing the secondary information may be performed by the context information management unit 210 or an external system separate from the management system 200.

To be specific, according to the example embodiment, the secondary information is a generic term which refers to meaningful information that can be obtained as a result of analyzing the primary context information by using an analysis technique such as a pattern analysis algorithm, a face recognition algorithm, a machine learning algorithm, or the like. By way of non-limiting example, the secondary context information may include information upon the number of people who stare at a display of the IoT device 500 as the target of management, information upon a matter of interest, a mood, and a purchase pattern of people who exist in the vicinity of a place where the IoT device 500 is installed, and so forth.

Here, however, it should be noted that the primary context information and the secondary context information may not be limited to the aforementioned examples and may be modified in various ways.

The PaaS management unit 220 of the example embodiment is configured to perform a function of providing the developer device 400 or the supplier server 300 with the primary context information or the secondary context information acquired as described above through a PaaS (Platform as a Service) which supports an application or a content to be provided by at least one IoT device. Here, the PaaS refers to a service as a platform which provides virtualized hardware and software as required by the developer and provides all kinds of environments and processes related to development of software. The term “PaaS” used in the present disclosure should be understood as a generic term including similar concepts such as SaaS (Software as a Service), BaaS (Backend as a Service), IaaS (Infrastructure as a Service), etc.

Thus, according to the example embodiment, the developer or the supplier who recognizes and understands the context information regarding the IoT device 500 through which an application or a content to be developed or supplied by the developer or the supplier will be provided is enabled to develop or supply an application or a content suitable for the context of the IoT device 500.

By way of example, assume that an application or a content is provided in the IoT device 500 installed on a product tray of a store. In this case, the PaaS management unit 220 according to the example embodiment may extract, from a moving picture (primary context information) captured for the vicinity of the product tray, context information (secondary context information) that more than 50% of the people who stand in front of this product tray is women in their twenties having a body weight above an average. The developer or the supplier who is informed of this secondary context information may create or provide an application or a content of introducing useful diet food as an application or a content to be displayed on the IoT device 500.

Further, according to the example embodiment, the PaaS management unit 220 is also configured to perform a function of determining at least one library related to the primary context information or the secondary context information among various libraries supported by the PaaS, and providing the developer device 400 or the supplier server 300 with the at least one determined library through the PaaS. According to the example embodiment, the library provided to the developer device 400 or the supplier server 300 may be a set of programs that can be used to implement a part of components of the application or the content. In some cases, however, the library provided to the developer device 400 or the supplier server 300 may be the application or the content itself.

To elaborate, according to the example embodiment, the PaaS management unit 220 may construct or produce a context information-library map in which context information of the IoT device and a library are matched with reference to a topic (keyword), an attribute, a matching history, or the like. Based on this context information-library map, it is possible to determine the library adequate for the context information involved.

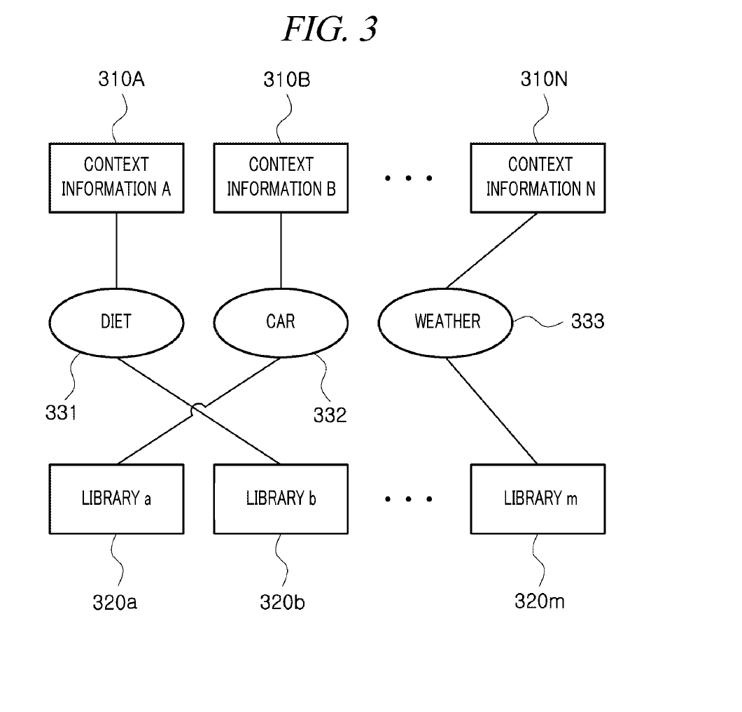

FIG. 3 is a diagram showing a configuration in which context information of the IoT device is matched with a library according to the example embodiment. As depicted in FIG. 3, a context information-library map in which context information 310A, context information 310B and context information 310N are matched with a library 320a, a library 320b and a library 320m, respectively.

For example, if there is derived the context information that attention to the IoT device 500 is increased when weather information is provided by the IoT device 500 installed in a bus stop, the PaaS management unit 220 of the example embodiment may provide the developer device 400 or the supplier server 300 with a library which can be utilized to implement a function of providing detailed weather information to allow the developer or supplier to create or supply an application or a content specialized for weather information.

Further, the communication unit 230 according to the example embodiment is configured to perform a function of enabling transmission/reception of data from/to the management system 200.

The control unit 240 according to the example embodiment may perform a function of controlling a data flow between the context information management unit 210, the PaaS management unit 220 and the communication unit 230. That is, the control unit 240 according to the example embodiment is capable of controlling the context information management unit 210, the PaaS management unit 220 and the communication unit 230 to perform their own functions by controlling a data flow from/to the outside of the management system 200 and a data flow between the individual components of the management system 200.

The above-described example embodiments may be embodied in the form of program instruction codes that can be executed by various computer components and stored in a computer-readable recording medium. The computer-readable recording medium may include program instruction codes, data files and data structures alone or in combinations. The program instruction codes recorded in the computer-readable recording medium may be designed and composed for the purse of present disclosure or may be commonly known and available to those skilled in the field of computer software. Examples of the computer-readable recording medium include a magnetic medium such as a hard disk, a floppy disk or a magnetic tape, an optical medium such as a CD-ROM or a DVD, a magneto-optical medium such as a floptical disk, and a hardware device, such as a ROM, a RAM or a flash memory, which is specially designed to store and execute program instruction codes. Examples of the program instruction codes include high-level language codes capable of being executed by using an interpreter or the like as well as machine language codes created by a compiler, for example. The hardware device may be changed to at least one software module to perform the process of the example embodiments, and vice versa.

The above description of the example embodiments is provided for the purpose of illustration, and it would be understood by those skilled in the art that various changes and modifications may be made without changing technical conception and essential features of the example embodiments.

Thus, it is clear that the above-described example embodiments are illustrative in all aspects and do not limit the present disclosure. The scope of the inventive concept is defined by the following claims and their equivalents rather than by the detailed description of the illustrative embodiments. It shall be understood that all modifications and embodiments conceived from the meaning and scope of the claims and their equivalents are included in the scope of the inventive concept.

1. A method of providing context information regarding an IoT (Internet of Things) device, comprising:
acquiring primary context information which is collected for at least one IoT device, and secondary information which is derived by analyzing the primary context information; and
providing the primary context information or the secondary context information to a developer device or a supplier server through a PaaS (Platform as a Service) configured to support an application or a content to be provided by the at least one IoT device.

2. The method of claim 1,
wherein the primary context information or the secondary context information includes at least one of information upon a state of the at least one IoT device, information detected by a sensor related to the at least one IoT device, and public information collected from an external server.

3. The method of claim 1,
the providing of the primary context information or the secondary context information comprises:
determining at least one library related to the primary context information or the secondary context information among libraries supported by the PaaS, and providing the determined at least one library to the developer device or the supplier server through the PaaS.

4. The method of claim 3,
wherein the at least one library is matched with the primary context information or the secondary context information in a context information-library map which is produced with reference to at least one of a topic, an attribute and a matching history.

5. A non-transitory computer-readable recording medium having stored thereon computer-executable instructions that, in response to execution, cause the method as claimed in claim 1 to be performed.

6. A system which provides context information regarding an IoT (Internet of Things) device, comprising:
a context information management unit configured to acquire primary context information which is collected for at least one IoT device, and secondary information which is derived by analyzing the primary context information; and
a PaaS (Platform as a Service) management unit configured to provide the primary context information or the secondary context information to a developer device or a supplier server through a PaaS configured to support an application or a content to be provided by the at least one IoT device.
